(19) United States
(12) Patent Application Publication
(10) Pub. No.: US 2012/0193349 A1
(43) Pub. Date: Aug. 2, 2012

(54) HEATING LAYERS CONTAINING VOLATILE COMPONENTS AT ELEVATED TEMPERATURES

(75) Inventor: Michael Joseph CALLAHAN, Hanson, MA (US)

(73) Assignee: GREENTECH SOLUTIONS, INC., Arlington, MA (US)

(21) Appl. No.: 13/361,473

(22) Filed: Jan. 30, 2012

Related U.S. Application Data
(60) Provisional application No. 61/437,015, filed on Jan. 28, 2011.

(51) Int. Cl. H05B 6/02

(52) U.S. Cl. 219/600

(57) ABSTRACT

A heating apparatus and methods for locally heating at least one layer composition including one or more volatile compounds is disclosed. The apparatus and methods allow for higher performance thin film electronic materials and novel thin film electronic materials to be manufactured including thin film photovoltaic cells.

### RELATED APPLICATIONS

This application claims the benefit of provisional patent application U.S. Ser. No. 61/437,015, filed Jan. 28, 2011, the content of which is hereby incorporated by reference.

### FIELD OF INVENTION

This application relates generally to processing of thin film materials, and more specifically to semiconductor thin film materials, and most specifically to the fabrication of thin film photovoltaic (TFPV) semiconductor materials containing volatile compounds on a large low-temperature substrates.

### BACKGROUND

Commodity electronics on low-temperature substrates has many applications, such as battery storage, thin film photovoltaics (TFPV), solid state lighting, radio frequency identification (RFID) tags, flexible displays, organic light emitting diodes (LEDs) and many others. These electronics are typically formed by depositing thin films of electronic and optical materials or precursors to the materials on substrates. The thin films are heated to activate the electrical or optical properties of the materials, reduce the number of defects in the materials, and in many cases convert the precursor materials to a desired crystallographic and chemical phase of a semiconductor material. Many desired semiconductor materials consist wholly or partially of chemical compounds that are volatile. Accordingly, when these compounds are heated in air or vacuum, at least a percentage of their solid volume vaporizes and is removed from the solid or liquid phase of the compound during heat processing.

For example, TFPV cells composed of copper zinc tin sulfide (CZTS), copper indium gallium selenide (CIGS), and cadmium telluride (CdTe) evaporate significant amounts of Sulfur (S), Selenium (Se), and Tellurium (Te) when heated above 500° C. The high efficiency laboratory cells are typically grown with Se vapor or annealed in Se or H₂Se vapor for long periods of time, i.e., typically greater than 30 minutes. This process is not cost effective in manufacturing. Current formation and annealing methods for these materials employ temperatures significantly below the melting points of CIGS, CdTe, and CZTS to avoid or reduce evaporation. CIGS and CdTe TFPV device manufacturing lines may use the following techniques for annealing: a) pressurizing the whole process chamber with large amounts of the volatile material; b) attaching expensive or bulky materials that are in contact with the thin film, which prevents the volatile compounds and elements from evaporation; and c) annealing at low temperatures typically less than 600° C. for CIGS and CdTe for long periods of time. All of these steps either add significant cost to the manufacturing process or produce inferior material that may translate into lower device performance for large-scale high-throughput manufacturing compared with devices fabricated in the lab using long duration deposition and annealing methods. Several techniques known in the art have also tried to reduce the amount of vaporous compounds that evaporate during annealing by incorporating an excess amount of the volatile compound which is subsequently evaporated away during the annealing process.

The current methods do not sufficiently reduce the evaporation rate of the volatile compounds contained in many thin films to enable annealing, partial melting, and complete melting at elevated temperatures. Higher temperatures are desired for rapid conversion of precursor materials to highly uniform semiconductor thin films that can reproducibly demonstrate desired electronic and optical properties. Annealing of semiconductors has much faster kinetics at temperatures approaching 60-80% of the melting point, i.e., 600-900° C. for CIGS, CdTe, and CZTS and therefore would be desirable over lower temperature methods currently known in the art. For some materials and applications, melting of the layers discussed above may be preferred over annealing. Volatile compounds may be formed by melting these compounds under substantial partial vapor pressures of the volatile components in closed vessels or containers to prevent decomposition of the compounds. Unfortunately, forming copious amounts of vapor at high pressure is impractical and costly for the melting of high-volume low-cost thin films such as TFPV at the manufacturing level. Therefore, it is desirable in manufacturing to heat layers for a short duration to reduce labor, equipment, energy and other costs.

However, one of the biggest technical hurdles in high-volume thin film manufacturing remains to be the ability to substantially reduce the evaporation of the toxic, expensive, and rare vapors contained in these compounds during annealing or other heat processing methods in a cost effective manner.

Traditional annealing techniques may be impractical to use in low-cost high-volume commodity electronics due to the prohibitive cost of the equipment and materials. Additionally, the low cost glass, metal foils, or plastic substrates used in commodity electronics typically cannot withstand high temperatures particularly when combined with the corrosive nature of many of the vapors used in the annealing process.

Several methods known in the art are used to rapidly deposit precursors of a desired semiconductor material on a substrate. One or more thin layers of the precursors are heated or annealed at low temperatures to form the final electronic grade material. Current state of the art low-temperature low-pressure annealing methods in high-volume commodity thin film manufacturing processes produce semiconductor thin films that are not uniform, have undesired chemical or crystallographic phases, and are deficient in one or more of their volatile elements or compounds. Non-uniformity, multiple phases, and non-stoichiometry can degrade the desired electronic, optical, or semiconductor properties of the thin film.

An exemplary conventional annealing method is illustrated in FIG. 1. The method illustrated in FIG. 1 may be used to anneal semiconductor materials containing volatile compounds in manufacturing of photovoltaic modules. One or more layers 44 of the desired semiconductor materials and/or precursor materials are formed on electrode material 42. Electrode material 42 is formed on substrate 40. Substrate 40 and the additional formed layers 42 and 44 are heated within an enclosure 20. Enclosure 20 typically includes volatile vapor-containing atmosphere 30 that limits the evaporation of the volatile vapor from layer 44 during heating. Enclosure 20 may also allow for volatile vapors from atmosphere 30 to diffuse into layer 44. A heating source of continuous EM radiation 12 is projected through a window 22 onto heated layer 52. Window 22 is transparent to the heating source and serves to focus EM radiation 12. Heated portion 52 of layer 44 absorbs the radiation from the heating source, converting layer 44 into a contiguous semiconductor film 62 with desired semiconductor properties. When a low pressure atmosphere and/or relatively high temperatures are used, a copious amount of the volatile compounds contained in layer 44 evaporates out of layer 44 as vapors 54.

Current state of the art heating/annealing techniques used for massive volume semiconductor markets, such as TFPV and flexible electronics, have significant reductions in manufacturing performance metrics over those that can be achieved in the laboratory. Additionally, it would be highly desirable, in order to lower cost and improve performance of many different commodity electronics, if low-cost and energy-efficient large sheets of uniform light, electron, or other EM sources could be conceived of and developed for rapid heating of the active layers of commodity devices on low temperature substrates such as TFPV.

Therefore, there is a need for a low cost, efficient method and apparatus to rapidly heat and in many cases additionally melt materials containing volatile compounds at elevated temperatures without substantial evaporation of the volatile compounds to form contiguous thin films including TFPV films of semiconductor materials processed on large sheets of flexible or fixed substrates.

### SUMMARY

Embodiments of the present invention provide a method for processing a multilayer material comprising at least one volatile layer. The method includes providing a multilayer material including a volatile layer, wherein the volatile layer contains at least one volatile compound. An encapsulant is deposited on an exposed surface of the volatile layer. The multilayer material including the volatile layer and the encapsulant is moved relative to a source of electromagnetic radiation for less than about a second. The method further includes heating at least a portion of the volatile layer by exposing at least a portion of the volatile layer to the source of electromagnetic radiation during the moving for less than about a second. The encapsulant layer prevents the at least one volatile compound of the volatile layer from evaporating during or after the heating. When the heat treatment is terminated, a functional device that includes the multilayer material and the encapsulant is formed. The encapsulant becomes a part of the final functional device. The encapsulant is not removed from the multilayer material after the heat treatment is completed.

Embodiments of the present invention further provide a system comprising an enclosure, a source of electromagnetic radiation and a multilayer material provided within the enclosure, and a translation system. The source of electromagnetic radiation emits radiation in visible or infrared spectrum. The multilayer material includes a volatile layer and an encapsulant provided on an exposed surface of the volatile layer. The multilayer material is positioned to receive the electromagnetic radiation from the source. The translation system moves the multilayer material including the volatile layer and the encapsulant relative to the source of electromagnetic radiation for less than about a second while the source of electromagnetic radiation emits radiation. The volatile layer contains at least one volatile compound. At least a portion of the volatile layer is heated by exposing at least a portion of the volatile layer to the source of electromagnetic radiation during the moving.

### BRIEF DESCRIPTION OF THE DRAWINGS

The accompanying drawings, which are incorporated in and constitute a part of this specification, illustrate one or more embodiments of the invention and, together with the description, explain the invention. In the drawings:

FIG. 1 illustrates heating of a multilayer structure without an encapsulant layer, according to conventional heating methods;

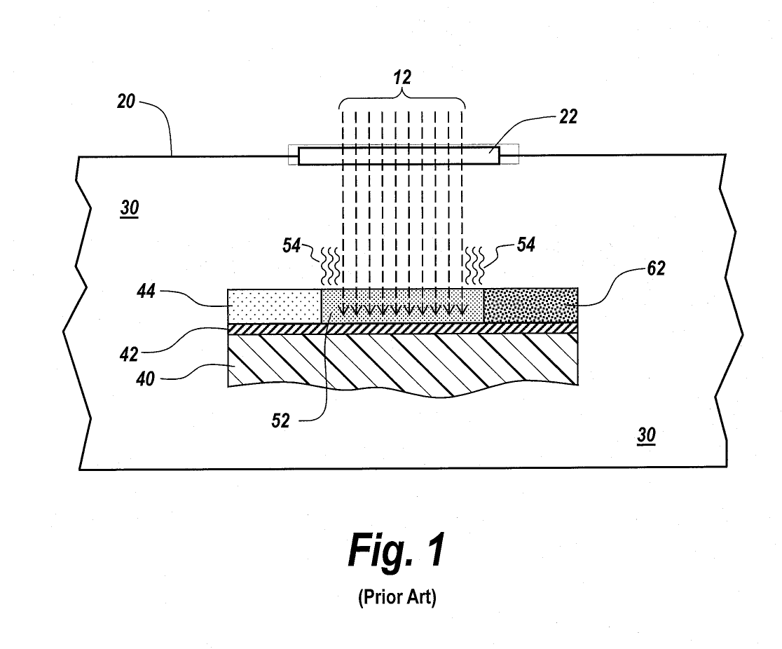

FIG. 2 illustrates a multilayer structure, such as an exemplary TFPV stack, according to various embodiments of the present application;

FIG. 3A illustrates an exemplary setting for annealing semiconductor layers containing volatile compounds without substantial evaporation of the volatile compounds according to various embodiments of the present application;

FIG. 3B illustrates the setting of FIG. 3A where a thin layer of vapor is generated over the semiconductor layer, below the encapsulant, according to various embodiments of the present application;

FIG. 4 illustrates a flowchart showing the steps for heating a multilayer material including at least one volatile layer to form a functional device;

FIG. 5 illustrates an exemplary reel-to-reel or roll-to-roll system for rapid heating of layers deposited on a flexible substrate according to various embodiments of the present application; and

FIG. 6 illustrates an exemplary flatbed system for rapid heating of layers deposited on a inflexible substrate according to various embodiments of the present application.

### DETAILED DESCRIPTION

Embodiments of the present invention allow forming a TFPV device that includes a TFPV stack with multiple layers. For example, an exemplary TFPV stack may include a substrate layer, a back electrode layer, an absorber semiconductor layer such as a CIGS layer, a window semiconductor layer and a front electrode layer. Each of the semiconductor layers may contain volatile elements (e.g., Cd, Te, Se and H). The TFPV stack may be subjected to heat processing, such as laser-annealing, to improve optical, electrical, and structure properties of the layers of the TFPV stack. During heat processing of the TFPV stack, the volatile elements of the heated layer or layers may evaporate. Embodiments of the present invention aim at keeping the volatile elements from substantially evaporating. To this end, an encapsulant layer may be formed on top of the upmost layer of the TFPV stack. The encapsulant layer itself may include multiple layers. The TFPV stack including the encapsulant layer(s) is heat processed, as described below. According to various embodiments of the present invention, the encapsulant is kept on the TFPV stack layers, i.e. is not removed, when the heat processing is completed, forming a part of the TFPV stack and any TFPV device formed using the TFPV stack.

The TFPV stack including the encapsulant layer(s) is heated/annealed using an infrared (IR) laser. The heating is referred as “sub-second” heating, as the heating is performed for less than 1 second. The electromagnetic (EM) radiation from the IR laser penetrates through a portion of the thickness of the CIGS layer. However, the EM radiation does not penetrate all the way through the CIGS layer. Accordingly, the electrode and substrate layers provided beneath the CIGS layer do not absorb the EM radiation of the IR laser and thus, are not heated by heat absorption. The top portion of the CIGS layer is heated by absorption while the bottom portion of the CIGS layer is heated to substantially the same degree by heat conduction. As a result, the substrate layer is prevented from heating to the same degree as the CIGS layer. For example, using techniques of the present invention, it is possible to heat the CIGS layer to about 700-1100° C. while maintaining the temperature of the substrate layer at about 400-600° C. According to various embodiments of the present invention, the TFPV stack may be laser-annealed in a dry air environment that contains oxygen and inert gas mixture. For example, the dry air environment may contain about 20% oxygen.

Using the teachings of the present invention, such as elevated local heating with containment of volatile components of thin layers and films, it is possible to increase throughput, lower cost, improve uniformity, and increase performance of thin film electronics during manufacturing of high volume thin films such as TFPV. Local elevated heating of the volatile layers and without heating the substrate layer may allow the use of low cost substrates with low melting points or operating temperatures. Method and apparatus disclosed herein limit or prevent the evaporation of volatile components while locally heating volatile layers on low-cost substrates.

A processed TFPV stack discussed herein generally includes a substrate that is contiguous and mechanically stable under human and/or machine handling, such that the substrate does not crack, rip, separate, or otherwise degrade. A substrate is a solid material on which one or more layers are synthesized, reacted, or otherwise formed. The substrate may be substantially thicker than the layers formed thereon to allow for mechanical stability. The substrate can be a single compound or can include many layers and compounds. Exemplary substrates include large single crystals, sheets of glass, including, e.g., soda lime glass, ceramic substrates, and long flexible sheets or foils that can be processed into rolls for use in a reel-to-reel translation systems. Examples of different compounds that may be used as substrate foils include steels, copper and copper alloys, aluminum and aluminum alloys, polyimide and other organic compounds, flexible glass sheets, large sheets of flexible single crystals, etc.

The layers of a TFPV stack typically include a back electrode, a p-type semiconductor compound that has desired photovoltaic properties (e.g., an absorber layer), a n-type semiconductor compound that has desired photovoltaic properties (e.g., a window layer), and a front electrode layer. As used herein, layer denotes portions or sections of one or more compounds that are synthesized, reacted, or otherwise placed on a substrate. The layer as a whole may be physically connected, may be porous or non-porous, may have portions of open and closed sections, may be composed of a single compound, or may be composed of many different compounds. A layer can be composed of more than one layer i.e., “sub-layers”. For example, a layer may be composed of several precursor layers which, when heated, form a semiconductor layer. The term “film” may be used interchangeably with the term “layer”, as a film is a subset of a layer. A “film” may also be defined as one or more converted “precursor layers” after heating or other processing has been performed. Heating converts the “precursor layers” into a “film” with desired electrical, optical, or structural properties.

A precursor denotes one or more layers in which heat treatment has yet to be performed. The precursors have nearly identical chemical elements as the converted thin film, but are composed of one or more different compounds or structures which are converted into the desired thin film upon heating and/or melting. The precursors may be one or more layers, and may also be composed of a matrix of compounds embedded in one or more layers. Vapor or gas components may also be a precursor, for instance if solid layers of precursor materials where surface is heated with an overpressure of one or more vapors.

As indicated above, a processed TFPV stack generally includes a substrate on which one or more layers are formed. The semiconductor layers of an exemplary TFPV stack may be composed of cadmium telluride (CdTe), copper indium gallium selenide (CIGS), and multi junction thin film silicon. The multi junction thin film silicon (Si) can have one or more layers of the amorphous, nanocrystalline, and microcrystalline forms of Si, such that at least a portion of at least one of the layers may be doped with hydrogen. As provided above, each of the semiconductor layers may contain volatile elements (e.g., Cd, Te, Se and H).

A volatile compound may include at least one component such that, when the compound is heated to a given temperature, the component has a partial vapor pressure greater than 1 kilopascal ( 1/100 Bar or ˜ 1/100 atmosphere). A volatile component typically has less than 1000° C. difference between the component's boiling point and the component's melting/sublimation point at atmospheric pressure. Volatile compounds may contain one or more volatile elements. Volatile elements may include: H, Na, K, Rb, Cs, Mg, Ca, Sr, Cr, Mn, Zn, Cd, Hg, Sm, Eu, Tm, Yb, C, N, P, As, Sb, O, S, Se, Te, F, Cl, Br, and/or I. Thin films of a variety of compounds containing volatile materials can be formed using the methods disclosed herein including: GaAs, InAs, AlAs, GaP, InP, AlAs, MgTe, ZnTe, CdTe, HgTe, MgSe, ZnSe, CdSe, HgSe, MgS, ZnS, CdS, HgS, CuInSe₂, CuGaSe₂, CuAlSe₂, CuInS₂, CuGaS₂, CuAlS₂, Cu₂ZnSnSe₄, Cu₂ZnSnS₄, Cu₂CdZnSe₄, Cu₂CdZnS₄, Ag₂ZnSnSe₄, AgZ₂nSnS₄, Ag₂CdZnSe₄, Ag₂CdZnS₄, hydrogenated Si, hydrogenated Ge, and alloys thereof.

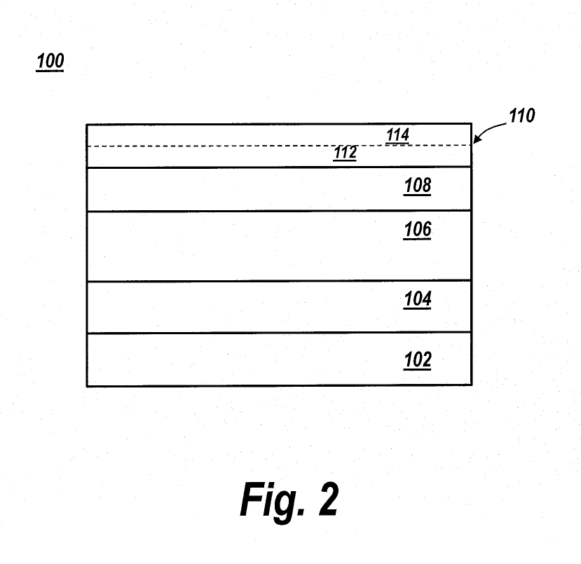

An exemplary TFPV stack is illustrated in FIG. 2. TFPV stack 100 that includes five layers 102, 104, 106, 108 and 110. Back electrode 104 is formed on top of substrate 102. The layers formed on top of back electrode 104 may include a layer of p-type semiconductor compound 106 (e.g., a CIGS layer), a layer of n-type semiconductor compound 108 (e.g., a CdS layer) and top electrode layer 110 (e.g., a transparent conducting oxide (TCO) layer). According to various embodiments, top electrode layer 110 layer may include one or more sub-layers. For example, top electrode layer 110 may include two zinc oxide (ZnO) sub-layers: a transparent ZnO sub-layer 114 formed on top of an insulating ZnO sub-layer 112. Transparent ZnO sub-layer 114 is transparent to a large portion of the solar spectrum. Transparent ZnO sub-layer 114 is preferably highly electrically conductive to enhance current transport.

According to various embodiments of the present invention, the thickness of a semiconductor layer may be about 0.01-10 micrometers (μm). For example, in the exemplary TFPV stack 100 illustrated in FIG. 2, top electrode layer 110, e.g., the TCO layer, may be about 1 μm, n-type semiconductor layer 108 may be about 0.05 μm, p-type semiconductor layer 106 may be about 1-2 μm and back electrode 104 may be about 0.5 μm.

Electrode layer 104 of TFPV stack 100 may be made of molybdenum. It is desirable to obtain good electrical contact between electrode layer 104 and CIGS 106 as well as between electrode layer 104 and substrate 102. Processing techniques may be used to reduce strain in the contact between substrate 102 and molybdenum electrode 104. The precursors contained in the layers can be various combinations of copper, indium, gallium, and selenium where the ratios of the sum of all the precursor are close to the stoichiometric ratio of the alpha-CIGS phase Cu(InGa)Se₂. An example of a set of precursors may include InGaSe, CuSe, and a small amount of excess Se. Another process known in the art called selenization may be used to deposit layers of Cu, In, and Ga, and in some cases Se alloy combinations of the components. The metallic layers may be annealed in Se containing vapor to form the CIGS layer. The precursors may be placed on top of each other as multiple layers or may be processed into particles or nanoparticles and mixed together in various configurations to form one or more layers of the TFPV stack.

According to various embodiments, CIGS layer 106 may have the following stoichiometry: In:Ga ratio close to 3; a Cu:(InGa) ratio slightly less than 1 (copper deficient); and a slight excess amount of Se than the stoichiometric ratio. It may also be desirable to add sodium to the CIGS precursors. Sodium may be provided by the soda lime glass substrate from which the sodium diffuses into the CIGS layers. Alternatively, sodium may be added as an additional component to the CIGS precursors contained in the layers. CIGS layer 106 formed with the above stoichiometry achieves high photovoltaic efficiency in the TFPV stack.

The order of the layers forming the TFPV stack is not limited to the order illustrated in FIG. 2. TFPV stack 100 may have a different order depending on, for example, whether substrate 102 is transparent to visible and near IR light. Exemplary TFPV stacks may include other films or layers such as buffer layers to prevent chemical reaction or relieve stress between layers. For example, a polymer, glass, or other moisture barrier may be formed, laminated, or otherwise attached the TCO layer and the substrate layer to prevent moisture forming on the TCO layer and the substrate layer. TFPV stack may also include an intrinsic semiconductor layer to improve carrier collection. Additional transparent contact layers may provided in the TFPV stack to allow for more light to be absorbed into the semiconductor layers and to improve current flow. Exemplary TFPV stacks may also include more than one p-n semiconductor junctions. Several TFPV stacks may be electrically connected to form a photovoltaic module.

As indicated above, the semiconductor films may be heated to either form the semiconductor layers from precursor layers or to improve the properties of the semiconductor layers. The heating may be performed by laser-annealing in a vacuum or a particular gaseous atmosphere. As used herein, annealing refers to heating a solid object without melting, i.e., without liquefying the solid object during heating. Embodiments of the present invention use sub-second heating. Currently, the most advanced heating method used in manufacturing is Rapid Thermal Annealing (RTA). RTA is annealing done in less than 10 minutes to more than a second using a continuous source of radiation. Accordingly, embodiments of the present invention heat the TFPV stack for a shorter period of time than RTA technique. Both the sub-second heating/annealing techniques of the present invention and RTA use banks of arc lamps, IR lamps, lasers—including but not limited to IR lasers, or filaments that emit light, i.e., electromagnetic (EM) radiation, in the ultraviolet (UV) to the infrared (IR) region. The emitted light is absorbed by the precursor layers and heats the precursor layers in the range of 10-100 s of degrees per second. The banks of lamps have large dimensions, typically greater than 10 cm wide and 10 cm long and thus, heat large areas simultaneously.

Using laser annealing according to various embodiments of the present invention, it is possible to preheat and/or post heat a glass or stainless steel substrate from room temperature to 600° C. Using laser annealing according to various embodiments of the present invention, it is possible to preheat and/or post heat the CIGS layer to rise the temperature of the CIGS to about 700-1100° C. for a period of time of less than 10 ms with continuous wave lasers or with laser pulses of less than 10 ms for a total time of less than 1 minute preferably less than 1 second.

Semiconductor layers containing volatile compounds may be annealed in such a way to avoid substantial evaporation of the volatile compounds. As used herein, in terms “substantially evaporate” and “substantial evaporation”, the term “substantial” denotes evaporation of at least 0.001% of a volatile compound to more than 25% of a volatile compound. The amount of evaporated material that is considered substantial depends on how the removal of a percentage of the volatile compound from the layers affects the mechanical, electrical, optical or other properties of the layers. For example, if the layers consist of GaAs in a 50%:50% atomic ratio, more than 0.1% arsenic (As) evaporation may be considered substantial as GaAs devices require the GaAs thin films in the device structure to be very close to stoichiometric ratios. For a CIGS layer formed of 24% Cu, 23% In, 7% Ga, and 51.8% Se, more than 2% evaporation of selenium (Se) may be substantial because TFPV stacks can have high performance with excess selenium concentration up to a few percent over stoichiometric ratios. Performance may degrade for TFPV stacks that is selenium deficient by more than a few tenths of a percent. Significant evaporation of material near the surface can significantly degrade devices. For example, a 2 micrometer CIGS film may have an average loss of Se from evaporation of 0.1% from a non-optimized localized heating method, but the top 50 nm may have a Se loss in excess of 5% preventing a proper junction from being formed when the full TFPV stack is processed.

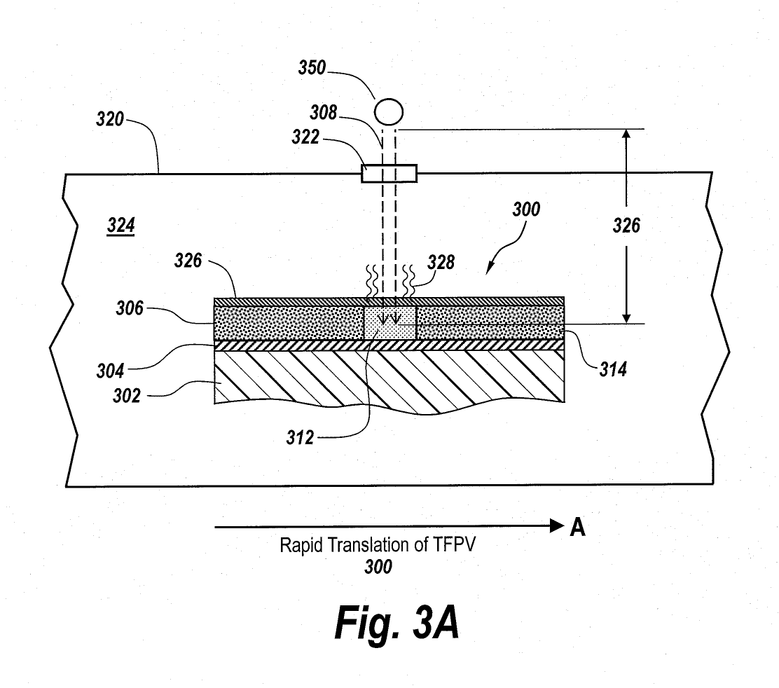

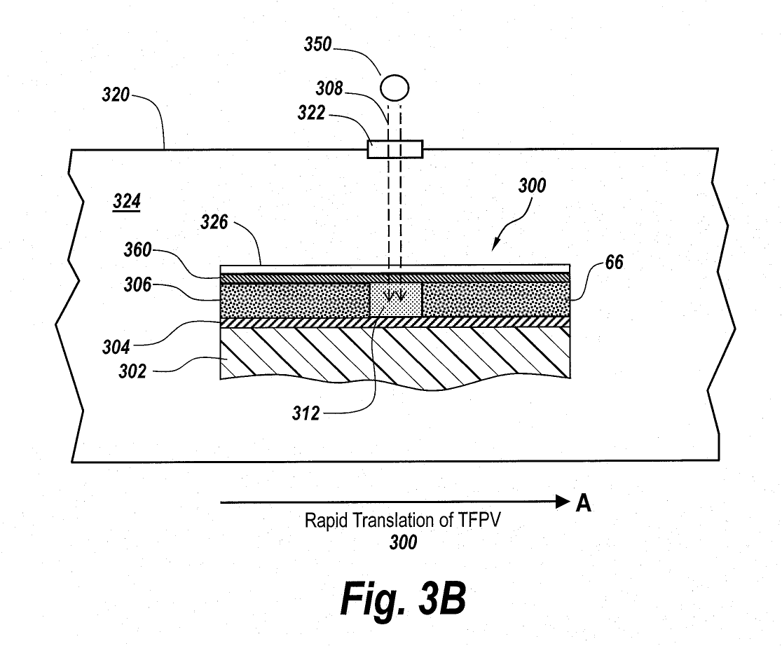

An exemplary setting according to various embodiments of the present invention for annealing semiconductor layers containing volatile compounds without substantial evaporation of the volatile compounds is illustrated in FIG. 3A. Multi-layered TFPV stack 300 includes electrode layer 304 formed on substrate 302. Electrode 304 can be made of molybdenum, copper, iron, various metallic alloys, or transparent conductive oxides (TCOs). Thereafter, one or more layers 306 of the desired semiconductor materials and/or precursor materials such as CdTe and CIGS may be formed on electrode layer 304. Layer 306 may be a CIGS layer that includes volatile compounds. TFPV stack 300 may be heated using EM radiation 308 emitted from a narrow EM heating source 350. The EM heating source 350 can include one or more of heated strips, heated wires, lasers, light emitting diodes, electron sources, ion sources, plasma sources, RF sources, microwave sources, arc lamps, flash lamps, IR lamps, and combinations thereof. For example, EM heating source 350 can be an IR laser.

According to various embodiments, TFPV stack 300 may move rapidly in a direction, i.e. direction A illustrated in FIG. 3A, perpendicular to EM radiation 308 during heating. In some embodiments, the heating source may be moved over a stationary TFPV stack if TFPV stack is a large inflexible device such as soda-lime glass sheets. According to yet other embodiments, multiple modes can be used for sub-second heating of a layer including volatile compounds where the layer and/or the EM source may move relative to each other to substantially reduce evaporation of volatile compounds during heating.

Referring back to FIG. 3A where TFPV stack 300 moves in direction A, EM radiation 308 penetrates though a portion of the top layers of TFPV stack 300. A portion of semiconductor layer 306 absorbs the EM radiation 308. Portions 312 of semiconductor layer 306 closer to the EM radiation absorbing location are heated through absorption while portions 314 of semiconductor layer 306 away from the EM radiation absorbing location are heated through heat conduction. The heat converts the portion of the layer under and near the EM heating source into a contiguous semiconductor film and/or improves properties of an existing semiconductor film. According to various embodiments, semiconductor layer 306 may be heated in an enclosure 320 with a narrow window 322 that is transparent to the EM heating source 350. At least part of the EM radiation emitted from the EM heating source 350 is in the visible or infrared (IR) spectrum. As used herein, the visible spectrum is defined as to include wavelengths between 380-750 nm and the IR spectrum is defined to include wavelengths greater than 750 nm. Preferably, the EM heating source 350 emits radiation with wavelengths equal to or greater than 380 nm. Specifically, for single junction TFPV layers such as CIGS, the preferred range is from around 700 nm-1200 nm which would allow for a significant light absorption depth of around 10% or greater and also be transparent to the CdS and ZnO layers.

In FIG. 3A, enclosure 320 can be a chamber or a dry, moisture-free environment such as a clean room. Window 322 may be made of materials mostly transparent to a certain form of EM radiation such as quartz, ZnS, ZnSe. Window 322 may also have an anti-reflective (AR) coating used for IR radiation. The walls of enclosure 320 may be constructed from any high purity steel or alloy. According to various embodiments, enclosure 320 may include atmosphere 324 which further limits the evaporation of volatile containing layer 306 during heating. Atmosphere 324 may include vacuum, an inert atmosphere, or a vapor pressure of the volatile compound.

Exemplary TFPV stack 300 illustrated in FIG. 3A may also include encapsulant layer 326 formed on top of semiconductor layer 306 to further limit the evaporation of volatile components during annealing. As used herein, an encapsulant is a material that at least partially encloses one or more layers or films. The encapsulant reduces or prevents evaporation of volatile compounds or elements from the layer(s) or film enclosed by the encapsulant during heating. The encapsulant may also protect the layer(s) or films enclosed by the encapsulant from a contaminating atmosphere such as air, water, oxygen, or other reactive vapors. The encapsulant may be the top layer of a plurality of layers. The encapsulant typically creates a seal that may prevent vapors from evaporating from volatile layers or from escaping if the encapsulant is non-porous. The encapsulant may keep a small amount of vapors locally confined to underneath the encapsulant and just above the layer beneath the encapsulant during heating. According to various embodiments of the present invention, the encapsulant may be non-porous to prevent the evaporation of the volatile compounds. Alternatively, the encapsulant may be porous, semi-porous, or leaky to allow the vapors evaporated from the volatile compounds to slowly escape thus still reducing or controlling the evaporation of the volatile compounds.

Any of the layers of TFPV stack 300 including the electrode, absorber layers, window layers, TCO layers and encapsulant may be formed by any deposition methods known in the art such as evaporation, sputtering, ink deposition, chemical bath deposition, and electrodeposition.

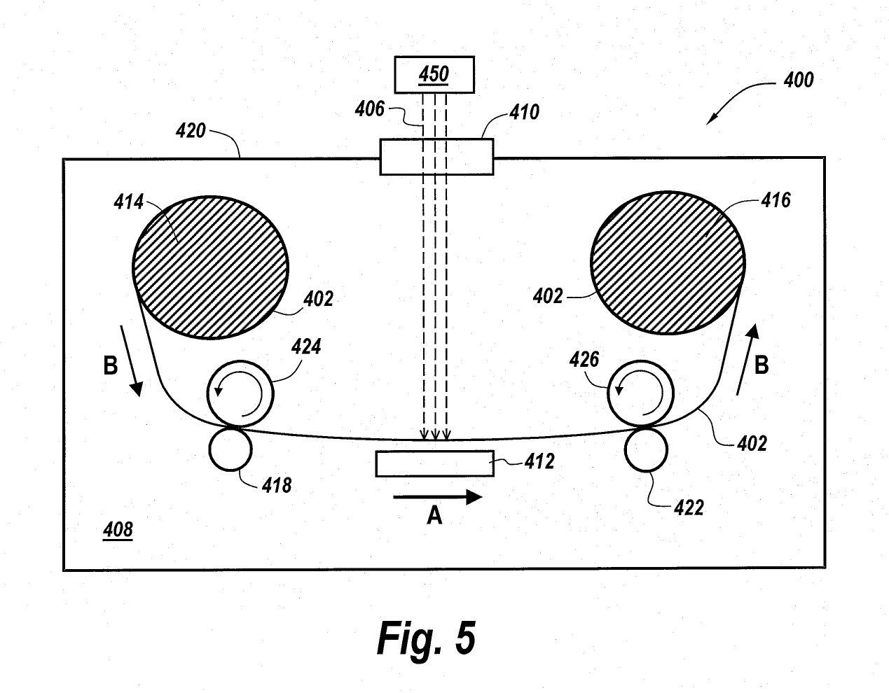

As provided above, TFPV stack 300 includes substrate 302. Substrate 302 may be relatively thick compared to the other layers to be inflexible. Inflexible substrate 302 may be composed of a glass, plastic, alloy or steel. An exemplary glass substrate may include soda-lime glass several millimeters thick with a 1 m² or greater area. Alternatively, substrate 302 may be flexible and processed into large rolls for roll to roll processing, as illustrated in FIG. 5. FIG. 5 is discussed below in greater detail. Suitable flexible substrates may be composed of Al, Cu, steel alloys, plastics, ceramic, flexible glass, and composite substrates. Thicknesses of the flexible substrates are generally less than a few hundred micrometers and may be less than 25 micrometers.

Referring back to FIG. 3A, semiconductor layer 306 is heated locally for about under a second, preferably under about a tenth of a second, and most preferably under about a millisecond. A narrow, long EM sheet 326 may be used for annealing semiconductor layer 306. An EM sheet is a long thin sheet of concentrated EM radiation that flows from the source of electromagnetic radiation and defines a cuboid or a prism with a quadrilateral or nearly quadrilateral cross-section that when directed onto a surface impinges that surface in the geometric form of a quadrilateral or near quadrilateral, preferably a square or rectangle. This does not preclude other geometries such as long ovals that are functional equivalents to a cuboid or prism being used to enable the methods herein. EM sheet radiation may readily be generated by one or more banks of semiconductor lasers with additional optics to disperse the radiation of each of the lasers into a long narrow sheet with a uniform intensity profile from one edge of the long length to the other edge. The emission wavelength of the lasers used in a laser sheet may be designed to emit at 200 nanometers to about 5000 nanometers with current or future laser technology and optics.

A length of EM sheet is a dimension of the EM sheet that is perpendicular to the direction of motion of layers. A long length is preferable as it allows one to process a large amount of layers simultaneously in parallel. For example, the length of the EM sheet may be more than about 1 centimeter, preferably more than about 10 centimeters, and most preferably more than about 50 centimeters. A width of EM sheet is a dimension of the EM sheet that is parallel to the direction of motion of layers. A short width may be preferable as it allows one to process the layers for a short duration, helping to avoid substantial evaporation of the volatile compounds. For example, the width of the EM sheet may be less than about 1 meter, more preferably less than about 1 centimeter, and most preferably less than about 1 millimeter. In the embodiments discussed herein, the length of the EM sheet is greater than the width of the EM sheet. A large length, to width ratio, preferably greater than 10, may be desired so a lot of material can be processed simultaneously. Thus large areas with linear dimension of greater than 10 centimeters and surface areas greater than 50 cm² may be heated in less than a second at rates greater than 1 degree per millisecond, preferably greater than 10 degrees per millisecond, and most preferably greater than 100 degrees per millisecond. According to various embodiments, EM radiation intensity uniformity along the length of the EM sheet may be >70%, preferably >90%, and most preferably >99%.

EM sheet 326 heats portions of semiconductor layer 306 having a surface area of greater than about 0.1 cm² with sub-second heating at rates greater than about 1 degree per millisecond, preferably greater than about 10 degrees per millisecond, and most preferably greater than about 100 degree per millisecond. Sub-second heating allows for less than about 25%, preferably less than about 10%, more preferably less than about 1%, and most preferably less than about 0.1% of the volatile compound to be evaporated during heating at elevated temperatures which may be more than 60% of the melting or sublimation point of the volatile compounds. The elevated heating temperatures may approach or exceed the melting point or sublimation point of certain volatile compounds depending on the process parameters used.

Exemplary process parameters may include but are not limited to: the duration of heating which may be less than about a second to more than about one picosecond; the temperature of the layers during heating; the rate of heating from the heating source; the rate of cooling after heating from the heating source; duration and temperature of one or more pre-annealing at a lower temperature using one or more separate heating source; duration and temperature of one or more post-quenching at a lower temperature using one or more separate heating and/or cooling source; the rate of movement of the layers through the primary and optional secondary heating sources; the intensity of the heating source over time i.e. temporal energy profile; the intensity of the heating source over the heating area i.e. geometric energy profile; the shape of the heating source; the absorption, reflection, emissive properties of the layers with the heating source; the atmosphere above the layer; the pressure above the layer typically from vacuum to 1 atm to 10 s of atmospheres; the thermal, mechanical, and optical properties of an optional encapsulant layer; the thermal mechanical and optical properties of the substrate, the electrode material, the substrate, and any additional layers such as the encapsulant and other additional layers; the size and shape of sub-components within the layers including nanoparticles; and the layers vertical position on top of the substrate relative to the sub-components.

During annealing, such as the exemplary annealing process illustrated in FIG. 3A, an unsubstantial amount of vapor 328 may evaporate from semiconductor layer 306 that includes volatile compound. If the heating is sufficiently rapid or if an optional encapsulant is used, a thin layer of vapor 360 may be generated over semiconductor layer 306, below encapsulant 326, as illustrated in FIG. 3B. Vapor layer 360 may form a local pressure gradient or bubble over semiconductor layer 306 during heating which further limits evaporation. The vapor pressure builds up over semiconductor layer 306 during heating and a pressure gradient remains directly over the heated layers to further limit evaporation until semiconductor layer 306 moves out of the heating zone and cools down. It may be preferred that no vapor of the volatile compound or any volatile components of the compound evaporate at all in which case there would not be any vapor 328 formed. In this embodiment, encapsulant 326 may have mechanical properties sufficient to substantially reduce to the point of elimination any evaporation 328 of semiconductor layer 306. Additional vapor pressure may be placed over encapsulant 326 to further reduce, eliminate, or even control the local vapor pressure immediately over semiconductor layer 306 during local heating from the EM source.

According to various embodiments, during or after localized heating with an EM source, a vapor pressure of one or more of the volatile compounds or elements may be placed in the same chamber or a different chamber where the localized EM heating takes place. Using this method, one or more of the volatile compounds or elements may be diffused into the near surface area, to replenish any small amount of evaporation of volatile compound or elements during the localized heating by the EM source.

Many volatile compounds have substantially lower equilibrium pressure and evaporation rates than those of the volatile elements in the compounds. For instance Se has an equilibrium pressure of 760 Ton at its melting point of 685° C., but In₂Se₃ has a selenium vapor pressure of only 35 Ton at its melting point of 895° C., providing an evaporation rate of substantially less than 1 μm/ms at its melting point. Thus one may anneal or melt precursors of CIGS materials above which is a thin layer of In₂Se₃ which is transparent to light below ˜650 nm with 808 and 920 nm lasers sheets and by using sub-second laser heating. In₂Se₃ in the layers below may simultaneously evaporate and dissolve. The In₂Se₃ is almost or completely removed during the heating of the CIGS layer and therefore does not have to be removed prior to depositing the window and contacts layers. In this way different encapsulant layers, the composition of the precursor layers and other processing parameters can be designed to obtain a well formed CIGS layer after sub-second heating with only a very small amount of selenium evaporation.

A small additional amount of Se or Se containing compounds may also be added near or on the surface of the CIGS layer that evaporate to form a localized Se containing vapor pressure during heating. The evaporated Se or Se containing compounds quickly condense on the surface of the crystallized CIGS during cooling with or without an encapsulant formed on top of the CIGS layer. A localized vapor of the volatile compounds even further slows the evaporation of these compounds while heating. The excess Se or Se containing compounds may be reacted or evaporated away after the encapsulant is removed or made to react with the underlying CIGS layer by heating if the encapsulant is not removed. Extreme rapid localized heating and melting in this case may be used in ambient conditions in many cases even without an encapsulant because the localize vapor pressure would limit contamination from the ambient environment. As discussed above, an enclosure containing a vacuum, an inert atmosphere, or a vapor pressure of the volatile compound may be used during the heat treatment to (i) avoid an undesired reaction of the layer and/or (ii) further reduce the rate of evaporation of the volatile compound from the layer.

Properties of the EM radiation used for annealing the TFPV stack will be discussed next. The emission spectrum of the EM radiation from the EM source preferably has a large absorption coefficient in the layers that are being heated. Optionally, the EM radiation source may omit multiple wavelengths of EM radiation and may optionally also be comprised of multiple sources. The emission spectrum or energy of the individual particles of the EM radiation may be used to control the depth of absorption of the EM radiation in the layers and thus the depth and profile of heating. It is highly desirable for the absorption to be at a depth where a significant amount of the radiation is absorbed into a significant thickness of the heated layer, e.g., CIGS layer, to allow for optimization of a heating profile and reduction of mechanical stresses during heating for multiple layers or sub-layers with different heat expansion properties. As used herein, a significant thickness is a thickness that may be defined as more than about 1% of a layer thickness, preferably more than 20% of a layer thickness, and most preferably more than 50% of the layer thickness. For instance for a layer thickness of about 1.5 micrometer (μm), which is typical for a CIGS layer, a significant thickness would be a thickness greater than 15 nanometers (nm), preferably greater than 300 nm, and most preferably a thickness greater than 750 nm.

The intensity of the EM radiation may be used to control the intensity of the heating in the layer to reach a desired temperature. Therefore a desired temperature to perform sub-second heating, annealing, or melting can be calculated and controlled to modify the chemical, crystallographic, or morphological properties of one or more layers to form a semiconductor compound by adjusting the emission spectrum of the EM particles emitted, the intensity or total number or flux of the particles, the rate of movement of the layers through the EM radiation, and the material properties of any layers and the substrate and the surrounding environment.

The EM radiation may be defined by its intensity and pulse shape. As used herein, a pulse denotes EM radiation that is turned on to flow from the EM radiation source and is subsequently turned off. According to various embodiments of the present invention, for a set time period, the EM radiation is on for part of the time and off for part of the time. According to various embodiments of the present invention, the intensity and/or pulse shape along the width of the EM radiation may be varied to control the heating of the TFPV stack layers. The EM radiation may be continuous as well as pulsed. For continuous-pulsed EM radiation, the intensity may be pulsed on and off, as well as pulsed from a lower intensity to a higher intensity. If the intensity of the EM is pulsed then the intensity may be periodic in nature such that each portion of the surface and portions parallel to the surface of the layers may receive near the same intensity in order to achieve uniform lateral heating throughout all the layers. According to various embodiments of the present invention, pulsing of the EM radiation may be adjusted during processing to allow for improved optical, electrical, and structure properties of the layers.

Pulsing of the EM radiation can also be used to shorten the heating time of the layers for greater reduction in evaporation. For example, the layers may be moved at 1 m/s across a 1 mm wide EM sheet. If a continuous pulse is used then the layers would be heated for 1 millisecond (ms). If a series of 5 pulses of 50 microsecond (μs) duration and 50 μs gap between pulses is employed, followed by 500 μs gap of no radiation, each portion of the layers would be heated for a total duration of 250 μs, rather than 1 ms duration for the continuous radiation. One of ordinary skill in the art can appreciate that many different pulse combinations may be employed to shorten the time the EM radiation is transmitted and absorbed into the layer during the movement of the layers.

Encapsulant

As provided above, an encapsulant layer may be provided as a top layer of an exemplary TFPV stack. Properties of the encapsulant layer will be discussed next. The thin film encapsulant may have a high emissivity to the EM radiation to efficiently couple the EM radiation through the encapsulant into the thin films. The encapsulant may be transparent or mostly transparent to the sheet of EM radiation, which can then be radiated through the encapsulant to heat or melt the underling layers. The layer and encapsulant can be translated through the sheet of EM radiation at a high rate for rapid heating or melting of the layer. Preferably the encapsulant has a higher melting or decomposition temperature than any of the layers heated or melted underneath and does not unduly contaminate the underlying layers with undesired impurities. Evaporation of vapors may be further reduced by annealing or melting the layer beneath the encapsulant in an ambient environment which results in ˜1 atmosphere of ambient pressure above the encapsulant. Evaporation may be even further reduced by heating or melting the material in a pressurized chamber of inert gas, such as Argon, at elevated pressures over 1 atmosphere.

According to various embodiments, the TFPV stack may be annealed in a vacuum. When annealing is performed in vacuum, the encapsulant may be designed to structurally withstand a pressure equal to or above the vapor pressure generated from a small amount of evaporated vapor. An equilibrium pressure may be obtained between the small amount of vapor above the surface of the layers and below the encapsulant. The encapsulant, when in the solid phase, may have elastic properties. Thus, the encapsulant may expand and contract slightly during the heating/evaporation and cooling/condensation as the layers are translated through the EM sheet. The thickness of the vapor generated may be thin enough to allow the electrons or photons to penetrate through the vapor and into the layers.

The elastic and or plastic properties of the encapsulant may be used to control the amount of vapor evaporated from the underlying layers to the point where the encapsulant does not allow any evaporation from the layers. Various encapsulants may be employed that soften or melt when subjected to the conductive heat from the layers below or absorption from the EM radiation. The softening or melting of the encapsulant does not introduce an excessive amount of impurities into the layers below that may degrade the desired material, electronic, or optical properties of the solid thin film or films. The evaporation rate may be controlled by using a porous or semi-porous encapsulant.

A mostly non-porous encapsulant with sufficient vapor pressure over the encapsulant may prevent nearly any evaporation from the heated layers. If the encapsulant is a volatile compound, a gaseous compound containing the volatile element of the encapsulant may be placed over the encapsulant in order to reduce or prevent the evaporation of the volatile encapsulant during localized heating by the EM source. For example, 5 atmospheres of dry air may be used to prevent the evaporation of a CIGS layer, the CdS layer, and the ZnO layer itself while laser annealing a SS/molybdenum/CIGS/CdS/ZnO device stack.

According to various embodiments, the encapsulant may dissolve in the underlying layers during the heating process as long as the encapsulant is composed of materials that do not degrade or harm the desired properties of the formed thin film. The encapsulant may be significantly thinner or completely removed after heat processing without applying mechanical or chemical removal techniques. The encapsulant may include an easily etched material, such as the water soluble salts i.e. NaCl, KCl, NaBr, NaI, NaF, SrF, etc. The salt encapsulant may be easily removed with an aqueous solvent after post heat processing.

According to yet other embodiments, the encapsulant may be kept on the TFPV stack layers, forming a part of the TFPV stack. The encapsulant may be composed of a material or a compound that does not reduce or only moderately reduce the electronic, optical, or structural properties of the material. For instance, the encapsulant may be a window material or transparent conducting oxide (TCO) that comprises at least one CdS, ZnS, MgS, CdSe, ZnSe, MgSe, ZnO, MgO, CdO, In₂O₃, SnO₂, TzO₂ and alloys thereof.

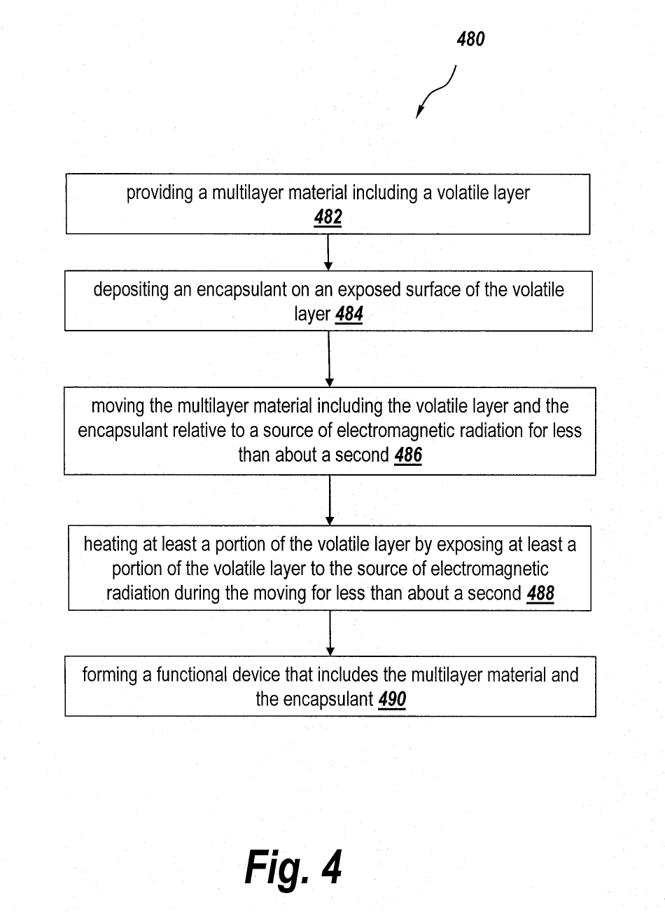

FIG. 4 illustrates a flowchart 480 showing the steps for heating a multilayer material including at least one volatile layer to form a functional device. The multilayer material including a volatile layer is provided (step 482). The volatile layer may contain at least one volatile compound. An encapsulant is deposited on an exposed surface of the volatile layer (step 484). The multilayer material including the volatile layer and the encapsulant is moved relative to a source of electromagnetic radiation for less than about a second (step 486). At least a portion of the volatile layer is heated by exposing at least a portion of the volatile layer to the source of electromagnetic radiation during the moving for less than about a second (step 488). The encapsulant layer prevents the at least one volatile compound of the volatile layer from evaporating during or after the heating. A functional device that includes the multilayer material and the encapsulant is formed at the end of the process (step 490). The functional device can be formed by using, for example, roll-to-roll processing or flatbed processing, among other types of processing that may be used to produce functional devices including multilayer materials.

FIG. 5 illustrates an exemplary reel-to-reel or roll-to-roll system 400 for rapid heating of layers deposited on a flexible substrate 402. A flexible substrate sheet or roll 402 may be placed on a translation system including a first and second rotating drums 414, 416. The first and second rotating drums 414, 416 may be driven by a motorized feedback system which may have a pair of primary wheels 424, 426 and a pair of secondary wheels 418, 422. One or more layers may be deposited on flexible substrate 402. Flexible substrate 402 and the layers deposited thereon may be wound as large rolls on the rotating drums 414, 416. When the system is in action, substrate 402 may move in direction A from moving drum 414 toward moving drum 416. The movement of substrate 402 unwinds substrate 402 from rotating drum 414 and winds substrate 402 around moving drum 416. While in motion, substrate 402 may past by a narrow EM radiation 406 emitted from primary heating source 450. EM radiation 406 is projected onto substrate 402. The layers deposited on substrate 402 may absorb the heat emitted from the primary heating source 450. Upon heating, the layers may convert into a contiguous semiconductor film with improved semiconductor properties. Alternatively, the heating may improve semiconductor properties of one or more existing layers. The layers may be heated in an enclosure 420 with a narrow window 410 that is transparent to the EM radiation 406. The enclosure 420 may include atmosphere 408 which further limits the evaporation of volatile compound containing layers during heating. A secondary heating source 412 may be used to either preheat or post-cool the layers while allowing the layers to stay at a temperature below where substantial evaporation takes place.

The primary and any secondary EM radiation sources 450, 412 may contain one or more heated strips, heated wires, lasers, light emitting diodes, electron sources, ion sources, a plasma sources, RF sources, microwave sources, arc lamps, flash lamps, IR lamps, and combinations thereof. EM radiation 406 may be a long narrow EM radiation sheet that may be generated by one or more banks of semiconductor lasers with additional optics to disperse the radiation of each of the lasers into a long narrow EM radiation sheet with a uniform intensity profile from one edge of the length of the EM sheet to the other edge. Preferably, for rapid heating times and low cost, the EM radiation sheet may have a narrow width and long length, in which photons or other emitted particles penetrate into and get absorbed by the layers deposited on substrate 402. According to various embodiments, exemplary EM radiation sheet may have an intensity uniformity of >70%, preferably >90%, and most preferably >99% along its length for uniform heating.

In the system illustrated in FIG. 5, the layers deposited on substrate 402 move across EM radiation 406. Alternatively, the EM source emitting EM radiation 406 may be moved and substrate 402 may be stationary. According to yet other embodiments, substrate 402 and the EM source may move at, for example, different velocities or directions. The main purpose is to have relative movement between substrate 402 and the EM radiation 406.

According to various embodiments, system 400 illustrated in FIG. 5 could use one or more of rollers, mechanics, hardware, software, and chamber materials for producing roll-to-roll commodity foils that are translated at a rate of greater than about 1 cm per second. Coherent Highlight series DS semiconductor line laser may be used as an exemplary heating source. The use of Coherent Highlight series DS semiconductor line laser is provided for illustrative purposes and should not be construed limiting. Various EM sources may be used in connection with the present invention.

According to yet other embodiments, enclosure 420 may be eliminated if a suitable encapsulant that is compatible with ambient environments or a dry ambient environment, e.g., a clean room, is used during the heating process. For processing in dry ambient environments or a suitable chamber, water absorbing equipment may be used to remove humidity before, during, and after the heat treatment. The EM source may also be located within the chamber for some types of EM radiation and chamber environments.

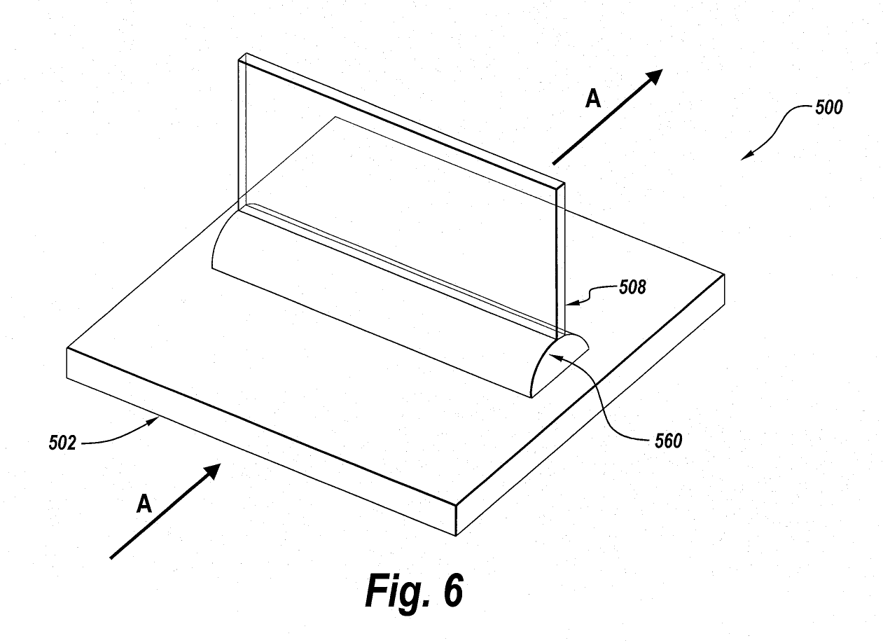

FIG. 6 illustrates an exemplary flatbed system 500 for rapid heating of layers deposited on a inflexible substrate 502. In system 500, large inflexible thick substrate 502 such as glass sheets, may be moved in direction A-A′ relative to the EM radiation 508 using a translation system. As illustrated in FIG. 6, a thin layer of vapor 560 may be generated below an encapsulant layer provided on substrate 502. FIG. 6 illustrates vapor layer 560 immediately beneath EM radiation 508. Vapor layer 560 may form a local pressure gradient or bubble over semiconductor layer which is formed on substrate 502, below the encapsulant layer. The local pressure gradient or bubble is formed during heating which to limits evaporation of volatile components form the semiconductor layer. A control system may be used to adjust the translation speed of substrate 502 and the properties of EM radiation 508 to heat a layer of substrate 502 for under a second, preferably under a tenth of a second, and most preferably under a millisecond and over a picosecond to a desired temperature.

### ILLUSTRATIVE EXAMPLES

### Example 1

(Prior Art): Annealing of CIGS with RTA for 20 seconds: Copper, Indium, Gallium metallic precursor layers with a total thickness of 2 μm may be sequentially deposited, for example, by sputtering on the surface of a 100 nm layer of molybdenum. The molybdenum is deposited on a 1 cm×10 cm soda-lime glass substrate. The substrate and layers formed thereon may be heated to 800° K (528° C.) for 1 minute in selenium vapor pressure of less than 200 Ton. The thin film of the CIGS produced after heating has reduced electro-optical properties compared to a CIGS film produced by using a long duration selenization annealing furnace.

### Example 2

Innovative sub-second heating of CIGS layer with e-beam according to exemplary embodiments of the present invention: Alternating layers of InSe, CuSe, and CuSe₂ with a total thickness of 2 μm may be evaporated on the surface of a 100 nm layer of molybdenum deposited on a 1 cm×10 cm soda-lime glass substrate. The layers and the substrate may be passed through an electron beam sheet 1 cm long and 0.1 mm wide in a vacuum at a rate of 1 meter/second. The electron beam sheet is set to an intensity and energy to penetrate about 2 μm and heats the InSe, CuSe, and CuSe₂ layers to about 800° K (628° C.). The InSe, CuSe, CuSe₂ are heated for 100 microseconds (μs) through the 1 mm width of the electron beam which is sufficient time to completely melt the InSe and CuSe layers, i.e. the majority of the layers liquefy. The layers are sufficiently close to each other for complete mixing by vapor/liquid/solid diffusion and dissolution upon liquefaction. The molten copper-indium-selenide (CIS) may be super-cooled to form a continuous layer of CIS with improved electrical properties and high uniformity. Only a small amount of Se may be lost through evaporation because of the 100 μs heating duration. The evaporated Se can be compensated by controlling the composition of the various layers achieving the desired chemical composition of the CIS film. The amount of Se lost through evaporation may be less than 0.1%. In this example, an annealing temperature 100° C. higher than that of example 1 can be achieved without heating the underlying substrate to over 500° C.

### Example 3

Laser annealing a CIGS layer using a ZnO film on top of a CdS film as an encapsulant according to exemplary embodiments of the present invention: A thin ZnO film may be deposited on top of a thin CdS film which may be deposited on the surface of a pre-formed CIGS layer deposited on a molybdenum-coated stainless steel foil roll. This example illustrates large scale roll-to-roll manufacturing of CIGS TFPV. The layers may be deposited on the roll by one or more deposition methods and techniques including, but not limited to, solution, evaporation, sputtering, co-evaporation or selenization. A system, such as one illustrated in FIG. 5, can be used to translate the layers over a sheet of coherent light 35 cm long by 1 mm wide by movement of the rollers at a rate of 500 mm/s. The system can be provided with 2 atmospheres of purified vapor consisting of 80% argon and 20% oxygen that has a water content of below 10 ppm. The laser light emanates from a laser light package containing a series of semiconductor laser bars. The laser light may pass through optics to obtain more than 90% uniformity in laser energy along the sheet's length. The laser light sheet may have an intensity peak at a wavelength of 975 nm. The laser light package may be attached to a device which allows lateral translation of the laser across the width of the stainless steel substrate. About ⅓^{rd} of the layers width may be translated across the laser sheet. A portion of the underlying layers may be heated for about 2 ms during the movement of the rollers on which the steel foil is provided. The CIGS layer may have a high absorption coefficient, e.g., about the 975 nm light. The CIGS layer may absorb the majority of the energy. The laser energy may penetrate into a majority of the thickness of the portion of the CIGS layer under the sheet of laser light before the majority of the laser light is fully absorbed.

The CdS and ZnO layers described in accordance with Example 3 may be designed to be mostly transparent to the laser light. The 975 nm laser intensity may be set to anneal the portion of a CIGS layer without melting at an elevated temperature, e.g., temperature greater than 600° C., by absorption of the laser light into a the majority of the CIGS layer. Nearby portions of the CIGS layer and portions of the other layers may also be primarily heated through heat conduction. The underlying substrate temperature may never rise above about 500° C. for more than about 2 milliseconds during the annealing process. Selenium, Cadmium, and Sulfur evaporation may be substantially suppressed by the ZnO encapsulant and the 2 atmospheres of vapor pressure applied on the top surface of the top layer. Evaporation of the ZnO encapsulant layer may also be completely suppressed by the oxygen partial pressure. The first ⅓ width of 1 meter (m) wide layers may be translated through the laser sheet from one end of the roll to the other end of the roll by movement of the rollers. The process may be repeated to heat the second ⅓^{rd} of the width of the layers with a small overlap of heating of layers between the first ⅓^{rd} and the second ⅓^{rd} of the 1 m width. Finally the process may be repeated to heat the last ⅓^{rd} of the 1 m width of the layers. The laser annealed CIGS layer and the laser annealed SS/CIGS/CdS/ZnO thin film stack have at least one improved chemical, optical, or electrical property that increases photovoltaic or electrical efficiency of modules made using the thin film stack.

### Example 4

Laser melting CIGS using CIGS nanoparticles at 800° C. with lasers according to exemplary embodiments of the present invention: A thin layer of In₂Se₃ may be sputtered on top of a 1.5 μm thick layer containing CIGS nanoparticles. The combination may be deposited by solution growth methods on a molybdenum layer. The molybdenum layer may be formed on top of a long flexible plastic sheet 1 m long and 1000 meters wide. The plastic sheet and the layers are placed into a roll-to-roll translation system similar to that illustrated in FIG. 5. The layers may be translated through a sheet of coherent light 1 meter long by 1 mm wide at a rate of 1 m/s. The laser light may emanate from a laser light package which contains a series of semiconductor laser bars. More than 90% uniformity in laser energy may be obtained along the length of the laser light sheet. The laser light sheet may have an intensity peak at a wavelength of about 920 nanometers. The intensity of the laser light may be pulsed with a period that consists of 5 pulses of 50 μs long with 50 μs spacing between the pulses followed by 50 μs of zero intensity. The CIGS nanoparticles may therefore be heated for a non-continuous duration of 25 μs in total and a repeating period of the pulse waveform of 1 millisecond. As a result, all of the layers may be evenly heated. During heating, the light may be passed through the transparent In₂Se₃ layer at a sufficient intensity to raise the temperature of the CIGS nanoparticles to 800° C. Light absorption of the CIGS nanoparticles may be below the melting point of the contiguous layer of In₂Se₃, but above a temperature that may normally degrade or soften the plastic sheet. The size and composition of the CIGS nanoparticles would be designed for full or nearly full melting to be achieved at below 800 ° C. During the heating process, the moving plastic sheet may be also translated through a 1 meter square heating zone centered on the sheet of coherent light. The 1 meter heating zone heats the plastic sheet and the layers formed on the plastic sheet to a maximum temperature of 300° C. After cooling to room temperature, the majority of the In₂Se₃ layer may be evaporated or dissolved into the CIGS layer. A contiguous thin film of CIGS may be formed with at least one improved property beneficial to TFPV stacks compared to the properties of the nanoparticles CIGS layer before annealing.

### Example 5

Laser melting CdTe using CdTe nanoparticles with 808 nm laser sheet according to exemplary embodiments of the present invention: A thin layer of CdS may be sputtered on top of a 3 μm thick layer containing CdTe nanoparticles. The CdTe may be previously deposited on top of a molybdenum layer. The molybdenum layer may be provided on top of a long flexible stainless steel sheet 1 meter long and 1000 meters wide. The steel sheet and the layers may be placed into a roll-to-roll translation system similar to that illustrated in FIG. 5. The system may be enclosed in a chamber containing 500 Ton of sulfur vapor. The chamber may include a window of 1 meter by 1 cm which is transparent to the 808 nanometer light. The layers may be translated through a sheet of coherent light 1 meter long by 0.5 mm wide at a rate of 5 m/s. The laser light may emanate from a laser light package which contains a series of semiconductor laser bars. More than 90% uniformity may be obtained in laser energy along the sheet's length. The laser light sheet may have an intensity peak at a wavelength of about 808 nanometers. The intensity of the laser light may be pulsed with a period that consists of 2 pulses of 5 μs long with 5 μs spacing between the pulses followed by 85 μs of zero intensity. The CdTe nanoparticles may therefore be heated for a non-continuous duration of 10 μs in total. A repeating period of the pulse waveform of 100 μs may allow all of the layers to be heated evenly. The light may pass through the transparent CdS layer. The CdTe nanoparticles may absorb the light and melt at a temperature significantly below the melting point of the contiguous layer of CdS provided above. After cooling to room temperature, a contiguous thin film of CdTe may be formed with improved properties compared to the properties of the nanoparticle CdTe layer before annealing.

### Example 6

Laser annealing a CIGS layer using a CdS film as an encapsulant according to exemplary embodiments of the present invention: A thin CdS film may be deposited on the surface of a pre-formed CIGS layer deposited on a molybdenum-coated stainless steel foil roll. This example is similar to the processing discussed in connection with Example 3. In the present example, the top layer is the CdS layer. Accordingly, the CdS layer acts as an encapsulant. The laser light emanates from a laser light package containing a series of semiconductor laser bars. The laser light may pass through optics to obtain more than 90% uniformity in laser energy along the sheet's length. The laser light sheet may have an intensity peak at a wavelength of 975 nm. The laser light package may be attached to a device which allows lateral translation of the laser across the width of the stainless steel substrate. About ⅓^{rd} of the layers width may be translated across the laser sheet. A portion of the underlying layers may be heated for about 2 ms during the movement of the rollers on which the steel foil is provided. The CIGS layer may have a high absorption coefficient, e.g., about the 975 nm light. The CIGS layer may absorb the majority of the energy. The laser energy may penetrate into a majority of the thickness of the portion of the CIGS layer under the sheet of laser light before the majority of the laser light is fully absorbed. A ZnO TCO layer may be formed on the top CdS layer after the laser annealing is performed. Accordingly, the resulting PFTV cell may be similar to that of Example 3. However, in the present example, the PFTV cell is formed using CdS layer as the encapsulant.

TFPV stacks and more specifically copper indium gallium selenide (CIGS) TFPV stacks are used herein as a representative example of the heating of layers containing volatile compounds to form a semiconductor films with desired optical, electronic, crystallographic, and other physical properties without substantially evaporating the volatile compounds. Many other electronic and optical devices that contain volatile compounds may be processed in a similar fashion.

According to various embodiments, additional layers can be added to the layers discussed above. For example, additional layers may include but are not limited to: layers to control the wetting properties of other layers, layers to more closely match the mechanical properties of at least portion of the layers to reduce the strain the substrate and one or more of the layers, layers to prevent contamination from other layers. For example, a wetting layer that is composed of one or more of the elements of the TFPV absorber layer such as copper for a CIGS layer may be placed between the electrode layer and the CIGS precursors. This intermediate wetting layer would enhance the wetting of the CIGS precursors to the electrode layer during the localized melting or partial melting of CIGS precursors by absorption of the EM radiation. The copper layer may be thin enough or dissolve into the CIGS during heating as to not negatively impact performance of a TFPV cell or module. The wetting layer may also be composed of a thin layer of materials not of the PFPV absorber layer such as Al in CIGS that may alloy with the CIGS to form a CAIGS layer. Another option would be to place an interface layer above the CIGS that may or may or may not also be an encapsulant, such as CdS to alter the wetting properties during melting or partial melting while not substantially degrading the performance of the final TFPV stack.

The foregoing description of embodiments is intended to provide illustration and description, but is not intended to be exhaustive or to limit the invention to the precise form disclosed. Modifications and variations are possible in light of the above teachings or may be acquired from a practice of the invention. It is intended that the invention not be limited to the particular embodiments disclosed above, but that the invention will include any and all particular embodiments and equivalents falling within the scope of the following appended claims.

What is claimed is:

1. A method for processing a multilayer material comprising at least one volatile layer, the method comprising:
providing a multilayer material including a volatile layer, wherein the volatile layer contains at least one volatile compound;
depositing an encapsulant on an exposed surface of the volatile layer;
moving the multilayer material including the volatile layer and the encapsulant relative to a source of electromagnetic radiation for less than about a second while the source of electromagnetic radiation emits radiation in the visible or infrared spectrums;
heating at least a portion of the volatile layer by exposing at least a portion of the volatile layer to the source of electromagnetic radiation during the moving for less than about a second, wherein the encapsulant layer prevents the at least one volatile compound of the volatile layer from evaporating during or after heating; and
forming a functional device that includes the multilayer material and the encapsulant.

2. The method of claim 1, wherein the volatile compound includes one or more of the following elements: Na, Rb, Cs, Mg, Zn, Cd, Hg, O, S, Se, Te.

3. The method of claim 1, wherein the encapsulant comprises at least a window layer including CdS, ZnS, MgS, CdSe, ZnSe, MgSe, and alloys thereof.

4. The method of claim 3, wherein the encapsulant comprises at least a transparent conducting oxide layer including ZnO, MgO, CdO, In₂O₃, SnO₂, TiO₂, and alloys thereof.

5. The method of claim 1, wherein the source of electromagnetic radiation emits radiation with wavelengths between about 700 nanometers and about 1200 nanometers.

6. The method of claim 1, wherein the electromagnetic radiation penetrates to a given depth of the volatile layer that is equal to or less than the entire thickness of the volatile layer.

7. The method of claim 6, further comprising:
heating portions of the volatile layer around the penetrated electromagnetic radiation by way of heat absorption, and
heating portions of the volatile layer away from the penetrated electromagnetic radiation by way of heat conduction, such that entire volatile layer uniformly heats to a temperature between about 700° C. and about 1100° C.

8. The method of claim 1, wherein the volatile layer is formed on a substrate layer and wherein the substrate layer is heated to a temperature equal to or less than about 600° C.

9. The method of claim 1, wherein the source of the electromagnetic radiation includes one or more of a heated strip, a heated wire, a laser, a light emitting diode, an electron sources, an ion source, a plasma source, a radio frequency source, a microwave source, an arc lamp and a flash lamp.

10. The method of claim 1 wherein heating at least a portion of the volatile layer comprises modifying at least one of the chemical, crystallographic, or morphological properties of the volatile layer.

11. The method of claim 1 wherein the volatile layer is formed using one or more of: MgTe, ZnTe, CdTe, HgTe, MgSe, ZnSe, CdSe, HgSe, MgS, ZnS, CdS, HgS, CuInSe₂, CuGaSe₂, CuAlSe₂, CuInS₂, CuGaS₂, CuAlS₂, Cu₂ZnSnSe₄, Cu₂ZnSnS₄, Cu₂CdZnSe₄, Cu₂CdZnS₄, Ag₂ZnSnSe₄, AgZ₂nSnS₄, Ag₂CdZnSe₄, Ag₂CdZnS₄, and alloys thereof.

12. The method of claim 1, further comprising:
applying the electromagnetic radiation continuously or in a pulsed manner.

13. The method of claim 12, further comprising:
varying an intensity or pulse shape of the electromagnetic radiation to control the heating of the multilayer material.

14. The method of claim 1, wherein the at least a portion of the volatile layer is heated within an enclosure comprising a vapor pressure of a volatile chemical element, compound which the encapsulant is composed of or dry air, and wherein the vapor pressure, along with the encapsulant, prevents the at least one volatile compound of the volatile layer from evaporating during or after heating.

15. A system comprising:
an enclosure;
a source of electromagnetic radiation provided within the enclosure, wherein the source of electromagnetic radiation emits radiation in the visible or infrared spectrums;
a multilayer material including a volatile layer and an encapsulant provided on an exposed surface of the volatile layer, wherein the multilayer material is provided within the enclosure and positioned to receive the electromagnetic radiation from the source; and
a translation system for moving the multilayer material including the volatile layer and the encapsulant relative to the source of electromagnetic radiation for less than about a second while the source of electromagnetic radiation emits radiation, wherein:
the volatile layer contains at least one volatile compound, and
at least a portion of the volatile layer is heated by exposing at least a portion of the volatile layer to the source of electromagnetic radiation during moving.

16. The system of claim 15, wherein the enclosure comprises at least one of a vacuum or an inert atmosphere.

17. The system of claim 15, wherein:
the enclosure comprises a vapor pressure of a volatile chemical element, compound which the encapsulant is composed of or dry air, and
the vapor pressure, along with the encapsulant, prevents the at least one volatile compound of the volatile layer from evaporating during or after heating.

18. The system of claim 15, wherein the vapor pressure is greater than 1 atmosphere.

19. The system of claim 15, wherein the source includes multiple semiconductor lasers and optics to produce a light sheet having a cross section in which photons are emitted that penetrate and are absorbed into the volatile layer of the multilayer material.

20. The system of claim 15, wherein the source of electromagnetic radiation emits radiation with wavelengths between about 700 nanometers and about 1200 nanometers.
